(19) United States
(12) Patent Application Publication
(10) Pub. No.: US 2012/0286192 A1
(43) Pub. Date: Nov. 15, 2012

(54) AZEOTROPE-LIKE COMPOSITIONS WITH 1,1,1,3,3-PENTAFLUOROBUTANE

(75) Inventor: John G. Owens, Woodbury, MN (US)

(73) Assignee: 3M Innovative Properties Company

(21) Appl. No.: 13/106,319

(22) Filed: May 12, 2011

(51) Int. Cl. C09K 5/04; C09D 7/12; C08J 9/06; C11D 17/00

(52) U.S. Cl. 252/67; 510/409; 510/408; 106/287.21; 106/287.28; 521/90; 521/98

(57) ABSTRACT

Azeotrope-like compositions comprising a blend of 1,1,1,3,3-pentafluorobutane and one of perfluoroheptane or perfluoro-N-methylmorpholine, and uses thereof, are described.

### TECHNICAL FIELD

This invention relates to azeotrope and azeotrope-like compositions containing 1,1,1,3,3-pentafluorobutane, and methods of using azeotropes and azeotrope-like compositions to clean substrates, deposit coatings, transfer thermal energy, and lubricate working operations.

### BACKGROUND

Chlorofluorocarbons (CFCs), hydrochlorofluorocarbons (HCFCs), and hydrochlorocarbons (HCCs, e.g., 1,1,1-trichloroethane and carbon tetrachloride) have been used in a wide variety of solvent applications such as drying, cleaning (e.g., the removal of flux residues from printed circuit boards), and vapor degreasing. These materials have also been used in refrigeration and heat-transfer processes. However, the photolytic and homolytic reactivity at the chlorine-containing carbon sites has been shown to contribute to depletion of the earth's ozone layer. Additionally, the long atmospheric lifetime of CFCs has been linked to global warming. As a result, there has been a world-wide movement to replace CFCs.

The characteristics sought in replacements, in addition to low ozone depletion potential, typically have included boiling point ranges suitable for a variety of solvent cleaning applications, low flammability, and low toxicity. For some applications, solvent replacements should also have the ability to dissolve both hydrocarbon-based and fluorocarbon-based soils. In some embodiments, solvent replacements also have low toxicity, have no flash points (as measured by ASTM D3278-98 e-1, “Flash Point of Liquids by Small Scale Closed-Cup Apparatus”), and have acceptable stability.

In some instances, azeotropes with one or more co-solvents are used to modify or enhance the solvent characteristics. Many azeotropes possess properties that make them useful as solvents. For example, azeotropes have a constant boiling point that avoids boiling temperature drift during processing and use. In addition, when an azeotrope is used as a solvent, the properties remain constant because the composition does not change during boiling or reflux. Azeotropes that are used as solvents also can be recovered conveniently by distillation.

### SUMMARY

In some embodiments, it is desirable to provide azeotrope-like compositions that have good solvent strength. In another aspect, in some embodiments, it is desirable to provide azeotrope-like compositions that have low flammability. In yet another aspect, in some embodiments, it is desirable to provide azeotrope-like compositions that are non-ozone depleting.

Briefly, in one embodiment, the present invention provides azeotrope-like compositions comprising a blend of 1,1,1,3,3-pentafluorobutane and one of perfluoroheptane or perfluoro-N-methylmorpholine.

In another embodiment, the present invention provides a coating composition comprising an azeotrope-like composition and at least one coating material soluble or dispersible in one or more of the azeotrope-like composition.

In yet another embodiment, the present invention provides a process for depositing a coating on a surface comprising applying a coating composition comprising an azeotrope-like composition to at least a portion of a surface, wherein the at least one coating material is soluble or dispersible in one or more of the azeotrope-like composition.

In yet another embodiment, the present invention provides a process for assisting in the removal of contaminants from the surface of a substrate comprising the steps of contacting the substrate with one or more of the azeotrope-like compositions according to the present invention until the contaminants are dissolved, dispersed, or displaced in or by the azeotrope-like composition, and removing the azeotrope-like composition containing the dissolved, dispersed or displaced contaminants from the surface of the substrate.

In yet another embodiment, the present invention provides a process for heat transfer wherein one or more of the azeotrope-like compositions according to the present invention is used as a heat-transfer fluid.

In another aspect, this invention provides a process for preparing polymeric foams. This process may involve vaporizing the azeotrope-like composition in the presence of at least one foamable polymer or the precursors of at least one foamable polymer. As used herein, reactive components that react with one another either during or after foaming to form a foamable polymer are regarded as precursors of a foamable polymer. In other aspects, this invention provides polymeric foams prepared from this process, and articles comprising the foams. The foams can vary from very soft types useful in upholstery applications to rigid foams useful as structural or insulating materials.

The above summary is not intended to describe each embodiment. The details of one or more embodiments of the invention are also set forth in the description below. Other features, objects, and advantages will be apparent from the description and from the claims.

### BRIEF DESCRIPTION OF DRAWINGS

Embodiments of the present disclosure are illustrated by way of example, and not limitation, in the accompanying drawings in which:

FIG. 1 is a schematic diagram of boiling point versus percent component A, illustrating an azeotrope and azeotrope-like region.

FIG. 2 is a graph of the boiling point versus the weight percent of 1,1,1,3,3-pentafluorobutane and perfluoroheptane illustrating one embodiment of the present invention;

FIG. 3 is a graph of the boiling point versus the weight percent of 1,1,1,3,3-pentafluorobutane and perfluoro-N-methylmorpholine illustrating one embodiment of the present invention;

### DETAILED DESCRIPTION

An azeotropic composition, or azeotrope, comprises a mixture of two or more substances that behaves like a single substance in which the vapor produced by partial evaporation of the liquid azeotropic composition at its boiling point has the same composition as the liquid.

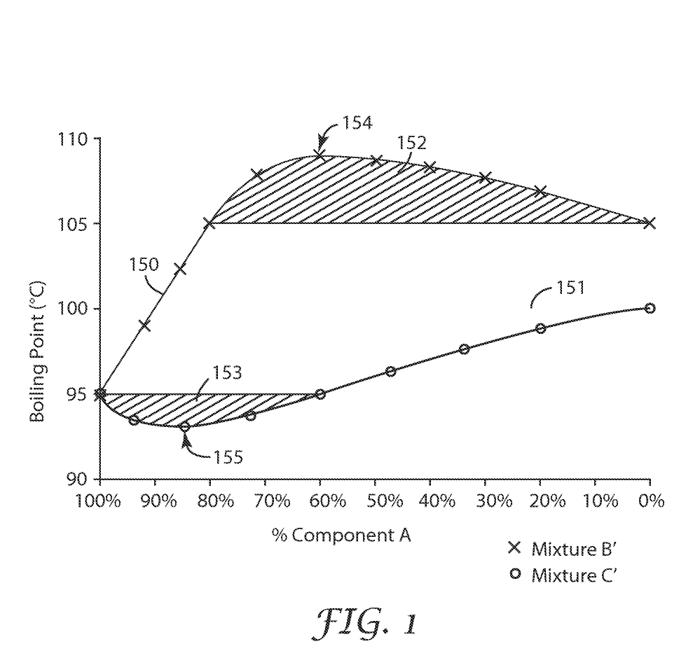

To define terminology, FIG. 1 will be used. Shown in FIG. 1 are two hypothetical mixtures, B′ and C′. Mixture B′ comprises components A and B. Mixture C′ comprises components A and C. Mixtures B′ and C′ are plotted as boiling point versus percent component A and are represented as curves 150 and 151, respectively. In FIG. 1, the boiling points of the individual components, A, B, and C are 95° C., 105° C. and 100° C., respectively.

Azeotropic compositions are constant boiling point mixtures that exhibit either a maximum boiling point that is higher than, or a minimum boiling point that is lower than, each of the individual components. In FIG. 1, the azeotrope of mixture B′ is represented by 154. This azeotrope has a boiling point that is higher than both component A and B. The azeotrope of mixture C′ is represented by 155. This azeotrope has a boiling point that is lower than both component A and C.

Azeotrope-like compositions boil at temperatures that are either above each of the individual components or below the boiling point of the each of the individual components. In FIG. 1, the azeotrope-like compositions for mixture B′ is represented by shaded area 152. Therefore, the B′ compositions comprising between 80% and greater than 0% of component are considered azeotrope-like and have boiling points that are higher than both component A and B. The azeotrope-like of mixture C′ is represented by shaded area 153. The C′ compositions comprising between 60% and less than 100% of component A are considered azeotrope-like and have boiling points that are lower than both component A and C. As can be seen in FIG. 1, the azeotrope composition is included in the range of azeotrope-like compositions for a particular mixture of substances.

The azeotrope-like compositions comprise a blend of 1,1,1,3,3-pentafluorobutane and a perfluorinated compound selected from one of perfluoroheptane or perfluoro-N-methylmorpholine. The concentration of the 1,1,1,3,3-pentafluorobutane and the perfluorinated compound in a particular azeotrope-like composition may vary substantially from the corresponding azeotropic composition, and the magnitude of this permissible variation depends upon the perfluorinated compound. In some embodiments, the azeotrope-like composition comprises essentially the same concentrations of the 1,1,1,3,3-pentafluorobutane and the perfluorinated compound as comprise the azeotrope formed between them at ambient pressure. In some embodiments, the azeotrope-like compositions exhibit no significant change in the solvent power of the composition over time.

Typically, azeotrope-like compositions retain some of the properties of the individual component solvents, which can enhance performance over the individual components because of the combined properties.

In addition to the 1,1,1,3,3-pentafluorobutane and the perfluorinated compound, other compounds that do not interfere in the formation of the azeotrope-like composition may be added. Typically, the other compounds will be present in small amounts. For example, in some embodiments, co-solvents or surfactants may be present to, for example, improve the dispersibility or the solubility of materials, such as water, soils, or coating materials (e.g., perfluoropolyether lubricants and fluoropolymers), in an azeotrope-like composition. In some embodiments, small amounts of lubricious additives may be present to, for example, enhance the lubricating properties of an azeotrope-like composition.

Azeotrope-like compositions comprise blends comprising a blend of 1,1,1,3,3-pentafluorobutane and one of perfluoroheptane or perfluoro-N-methylmorpholine; wherein the blend is selected from:

(i) wherein the blend consists essentially of less than 99.9 to about 75.1 weight percent of 1,1,1,3,3-pentafluorobutane and greater than 0.1 to about 24.9 weight percent of perfluoroheptane that boil below about 40.05° C. at about 760 torr (101 kilopascals);

(ii) wherein the blend consists essentially of less than 99.9 to about 13.5 weight percent of 1,1,1,3,3-pentafluorobutane and greater than 0.1 to about 86.5 weight percent of perfluoro-N-methylmorpholine that boil below about 40° C. at about 760 torr (101 kilopascals).

In some embodiments, the azeotrope-like compositions of the present invention have a boiling point of less than 75% of the boiling point depression from the lowest boiling point component to the minimum boiling point of the azeotrope-like composition. That is, if the boiling point of the lowest boiling point component is X (in ° C.), and the boiling point of the minimum boiling point of the azeotrope-like composition is Y (in ° C.), then the boiling point (in ° C.) of these azeotrope-like compositions would be less than X−0.25*(X−Y).

These azeotrope-like compositions of the present invention comprise blends of 1,1,1,3,3-pentafluorobutane and one of perfluoroheptane or perfluoro-N-methylmorpholine,

(i) wherein the blend consists essentially of less than 98.2 to about 76.5 weight percent of 1,1,1,3,3-pentafluorobutane and greater than 1.8 to about 23.5 weight percent of perfluoroheptane that boil below about 40.02° C. at about 760 torr (101 kilopascals);

(ii) wherein the blend wherein the blend consists essentially of less than 95.5 to about 15.5 weight percent of 1,1,1,3,3-pentafluorobutane and greater than 4.5 to about 84.5 weight percent of perfluoro-N-methylmorpholine that boil below about 38.8° C. at about 760 torr (101 kilopascals).

In some embodiments, the azeotrope-like compositions of the present invention have a boiling point of less than 50% of the boiling point depression from the lowest boiling point component to the minimum boiling point of the azeotrope-like composition. That is, if the boiling point of the lowest boiling point component is X (in ° C.), and the boiling point of the minimum boiling point of the azeotrope-like composition is Y (in ° C.), then the boiling point (in ° C.) of these azeotrope-like compositions would be less than X−0.5*(X−Y).

These azeotrope-like compositions of the present invention comprise blends of 1,1,1,3,3-pentafluorobutane and one of perfluoroheptane or perfluoro-N-methylmorpholine,

(i) wherein the blend wherein the blend consists essentially of less than 96.2 to about 78.5 weight percent of 1,1,1,3,3-pentafluorobutane and greater than 3.8 to about 21.5 weight percent of perfluoroheptane that boil below about 39.98° C. at about 760 torr (101 kilopascals);

(ii) wherein the blend wherein the blend consists essentially of less than 90.0 to about 17.0 weight percent of 1,1,1,3,3-pentafluorobutane and greater than 10.0 to about 83.0 weight percent of perfluoro-N-methylmorpholine that boil below about 37.7° C. at about 760 torr (101 kilopascals).

The azeotrope compositions of the present invention comprise blends of 1,1,1,3,3-pentafluorobutane and one of perfluoroheptane or perfluoro-N-methylmorpholine,

(i) wherein the composition is an azeotrope wherein the blend consists essentially of 88.7 weight percent of 1,1,1,3,3-pentafluorobutane and 11.3 weight percent of perfluoroheptane that boils at about 38.3° C. at about 732 torr (97.6 kilopascals);

(ii) wherein the composition is an azeotrope wherein the blend consists essentially of 49.1 weight percent of 1,1,1,3,3-pentafluorobutane and 50.9 weight percent of perfluoro-N-methylmorpholine that boils at about 34.3° C. at about 735 torr (98.0 kilopascals).

As is known in the art, the composition of the azeotrope will vary with pressure, e.g., as the ambient pressure increases, the boiling point of a liquid increases, and similarly, as the ambient pressure decreases, the boiling point of a liquid decreases. In some embodiments, the azeotrope-like compositions are homogeneous; i.e., they form a single phase under ambient conditions (i.e., at room temperature and atmospheric pressure).

The azeotrope-like compositions can be prepared by mixing the desired amounts of 1,1,1,3,3-pentafluorobutane and one of perfluoroheptane or perfluoro-N-methylmorpholine, and any other minor components (e.g., surfactants or lubricious additives) together using conventional mixing means.

In some embodiments, the azeotrope-like compositions may be used in cleaning processes, in heat-transfer processes, as a refrigerant, as a lubricating fluid, in the preparation of foams, and as a coating liquid, and the like.

Various different solvent cleaning and/or decontamination techniques are known in the art. In one embodiment, a cleaning process can be carried out by contacting a contaminated substrate with one of the azeotrope-like compositions of this invention until the contaminants on the substrate are substantially dissolved, dispersed, or displaced in or by the azeotrope-like composition, and then removing (for example, by rinsing the substrate with fresh, uncontaminated azeotrope-like composition or by removing a substrate immersed in an azeotrope-like composition from a bath and permitting the contaminated azeotrope-like composition to flow off of the substrate) the azeotrope-like composition containing the dissolved, dispersed, or displaced contaminant from the substrate. The azeotrope-like composition can be used in either the vapor or the liquid state (or both), and any of the known techniques for “contacting” a substrate can be used. For example, the liquid azeotrope-like composition can be sprayed or brushed onto the substrate, the vaporous azeotrope-like composition can be blown across the substrate, or the substrate can be immersed in either a vaporous or a liquid azeotrope-like composition. In some embodiments, elevated temperatures, ultrasonic energy, and/or agitation can be used to facilitate the cleaning

In some embodiments, the azeotrope-like compositions are also useful for removing contamination during semiconductor fabrication. For example, an integrated circuit or other small component may be exposed to the azeotrope-like composition to remove material not wanted on a surface, including photoresist residue, post-ion implant residue, post-etch residue, particulates, and even water. In some embodiments, the azeotrope-like compositions can be used in the decontamination of transistors or semiconductor devices that include gates, contacts, plugs, and interconnects (see U.S. 2009-0029274, Olson, et al., the disclosure of which is herein incorporated by reference). Especially useful may be the use of the azeotrope-like composition in substrates with an ion implanted region and/or metal gate.

In some embodiments, exemplary processes of the invention can be used to clean organic and/or inorganic substrates. Representative examples of substrates include: metals; ceramics; glass; silicon wafers; polymers for example polycarbonate, polystyrene, and acrylonitrile-butadiene-styrene copolymer; natural fibers (and fabrics derived there from) for example, cotton, silk, linen, wool, ramie, fur, leather, and suede; synthetic fibers (and fabrics derived therefrom) for example, polyester, rayon, acrylics, nylon, polyolefin, acetates, triacetates, and blends thereof; fabrics comprising natural and synthetic fibers; and combinations (e.g., laminates, mixtures, blends, etc.) of the foregoing materials. In some embodiments, the process is especially useful in the precision cleaning of electronic components (e.g., circuit boards); optical or magnetic media; and medical devices and medical articles for example syringes, surgical equipment, implantable devices, and prosthesis.

In some embodiments, exemplary cleaning and/or decontamination processes can be used to dissolve or remove most contaminants from the surface of a substrate. For example, materials such as light hydrocarbon contaminants; fluorocarbon contaminants such as perfluoropolyethers, bromotrifluoroethylene oligomers (gyroscope fluids), and chlorotrifluoroethylene oligomers (hydraulic fluids, lubricants); silicone oils and greases; photoresist, particulates; and other contaminants encountered in precision, electronic, metal, and medical device cleaning can be removed. In some embodiments, the process is particularly useful for the removal of hydrocarbon contaminants (especially, light hydrocarbon oils), fluorocarbon contaminants, and particulates.

In some embodiments, the azeotrope-like compositions are also useful for extraction. Here, cleaning involves removing contaminants (e.g., fats, waxes, oils, or other solvents) by dissolution or displacement of these materials from substances (e.g., naturally occurring materials, foods, cosmetics, and pharmaceuticals).

In some embodiments, exemplary azeotrope-like compositions can also be used in coating deposition applications, where the azeotrope-like composition functions as a carrier for a coating material to enable deposition of the material on the surface of a substrate, thus providing a coating composition comprising the azeotrope-like composition and a process for depositing a coating on a substrate surface using the azeotrope-like composition. The process comprises the step of applying to at least a portion of at least one surface of a substrate a coating of a liquid coating composition comprising (a) an azeotrope-like composition; and (b) at least one coating material that is soluble or dispersible in the azeotrope-like composition. The coating composition can further comprise one or more additives (e.g., surfactants, coloring agents, stabilizers, anti-oxidants, flame retardants, and the like). Preferably, the process further comprises the step of removing the azeotrope-like composition from the deposited coating by, e.g., allowing evaporation (which can be aided by the application of, e.g., heat or vacuum).

The coating materials that can be deposited by the process include: pigments, silicone lubricious additives, stabilizers, adhesives, anti-oxidants, dyes, polymers, pharmaceuticals, cosmetics, release agents, inorganic oxides, and the like, and combinations thereof. Preferred materials include: perfluoropolyethers, hydrocarbons, and lubricious additives; amorphous copolymers of tetrafluoroethylene; polytetrafluoroethylene; and combinations thereof. Representative examples of materials suitable for use in the process include: titanium dioxide, iron oxides, magnesium oxide, perfluoropolyethers, polysiloxanes, stearic acid, acrylic adhesives, polytetrafluoroethylene, amorphous copolymers of tetrafluoroethylene, and combinations thereof. Any of the substrates described above (for decontamination applications) can be coated. Particularly useful in one embodiment, is coating magnetic hard disks or electrical connectors with perfluoropolyether lubricants or medical devices with silicone lubricious additives.

To form a coating composition, the components of the composition (i.e., the azeotrope-like composition, the coating material(s), and any additive(s) used) can be combined by any conventional mixing technique used for dissolving, dispersing, or emulsifying coating materials, e.g., by mechanical agitation, ultrasonic agitation, manual agitation, and the like. The azeotrope-like composition and the coating material(s) can be combined in any ratio depending upon the desired thickness of the coating. In some embodiments, the coating material(s) comprise from about 0.1 to about 10 weight percent of the coating composition.

Exemplary deposition processes of the invention can be carried out by applying the coating composition to a substrate by any conventional technique. For example, the composition can be brushed or sprayed (e.g., as an aerosol) onto the substrate, or the substrate can be spin-coated. In some embodiments, the substrate is coated by immersion in the composition. Immersion can be carried out at any suitable temperature and can be maintained for any convenient length of time. If the substrate is a tube, such as a catheter and it is desired to ensure that the composition coats the lumen wall of the catheter, it may be advantageous to draw the composition into the lumen by the application of reduced pressure.

In some embodiments, after a coating is applied to a substrate, the azeotrope-like composition can be removed from the deposited coating by evaporation. In some embodiments, the rate of evaporation can be accelerated by application of reduced pressure or mild heat. The coating can be of any desired thickness. Generally, the thickness will be determined by, for example, such factors as the viscosity of the coating material, the temperature at which the coating is applied, and the rate of withdrawal (if immersion is used).

In some embodiments, the azeotrope-like compositions of the present invention can be used as heat-transfer fluids in heat-transfer processes where the heat-transfer fluids can transfer thermal energy (e.g., heat) either in a direct or indirect manner. Direct heat transfer (sometimes called “direct contact heat transfer”) refers to a heat-transfer process wherein a heat-transfer fluid conducts heat directly to and/or from a heat sink or source to a fluid by directly contacting the fluid with the heat sink or source. Examples of direct heat transfer include the immersion cooling of electrical components and the cooling of an internal combustion engine.

Indirect heat transfer refers to a heat-transfer process wherein a heat-transfer fluid conducts heat to and/or from a heat sink or source without directly contacting the fluid with the heat sink or source. Examples of indirect heat transfer include: refrigeration, air conditioning and/or heating (e.g., using heat pumps) processes, such as are used in buildings, vehicles, and stationary machinery. In other embodiments, a process for transferring heat is provided comprising employing an azeotrope-like composition as a secondary loop refrigerant or as a primary loop refrigerant. In these embodiments, the secondary loop refrigerant (i.e., a wide temperature range liquid fluid) provides a means for transferring heat between the heat source and the primary loop refrigerant (i.e., a low temperature-boiling fluid, which accepts heat by e.g., expanding to a gas and rejects heat by being condensed to a liquid, typically by using a compressor). Examples of equipment in which the azeotrope-like composition may be useful include: centrifugal chillers, household refrigerator/freezers, automotive air conditioners, refrigerated transport vehicles, heat pumps, supermarket food coolers and display cases, and cold storage warehouses.

In indirect heat-transfer processes, lubricious additives for heat transfer can be incorporated in the heat-transfer fluid where moving parts (e.g., pumps and valves) are involved to ensure that the moving parts continue to work over long periods of time. Generally, these lubricious additives should possess good thermal and hydrolytic stability and should exhibit at least partial solubility in the heat-transfer fluid. Examples of suitable lubricious additives include: mineral oils, fatty esters, highly halogenated oils such as chlorotrifluoroethylene-containing polymers, and synthetic lubricious additives such as alkylene oxide polymers. The azeotrope-like compositions can also function as a working fluid in an organic Rankine cycle, for example to recover energy from sources such as waste heat from industrial processes, geothermal heat, or solar heat.

In each of the described uses, the azeotrope-like composition can be used as such, or a blend of azeotrope-like compositions may be used, provided the blend also is azeotrope-like. Similarly, minor amounts of co-solvents can be added to the azeotrope-like compositions, provided the addition does not disrupt the azeotropic behavior. Useful co-solvents may include, for example, hydrofluorocarbons (HFCs), hydrocarbons, hydrochlorocarbons (HCCs), or water.

Polymeric foams can be prepared using foamable compositions (i.e., azeotrope-like compositions and at least one foamable polymer or the precursors of at least one foamable polymer) by vaporizing (e.g., by utilizing the heat of precursor reaction) at least one azeotrope-like composition in the presence of at least one foamable polymer or the precursors of at least one foamable polymer. The azeotrope-like compositions may be used as a blowing agent per se, or as a nucleating agent in combination with other blowing agents.

Whereas the blowing agent provides the essential volume to form the voids in the foamable resin that become the resultant cells in the finished foam, the nucleating agents provide the initiating sites at which the blowing agent forms the voids. By selection of a nucleating agent, one can obtain a foam with fewer relatively larger voids, or a foam with a greater number of relatively smaller voids.

In one embodiment precursors of the foamable polymer of the present invention include a polyol and an isocyanate. In making the polyisocyanate-based foam, the isocyanate (or polyisocyanate), polyol and azeotrope-like composition can generally be combined, thoroughly mixed (using, e.g., any of the various known types of mixing head and spray apparatus), and permitted to expand and cure into a cellular polymer.

It is often convenient, but not necessary to preblend certain of the components of the foamable composition prior to reaction of the isocyanate and the polyol. For example, the azeotrope-like composition may be added to the polyol to form a first mixture and then blended with the isocyanate before vaporization and polymeric foam formation. Alternatively, the azeotrope-like composition can be added to the isocyanate to form a first mixture and then blended with the polyol before vaporization and polymeric foam formation.

Polyisocyanates (or isocyanate precursors) suitable for use in the process of this invention include aliphatic, alicyclic, arylaliphatic, aromatic, or heterocyclic polyisocyanates, or combinations thereof. Any polyisocyanate that is suitable for use in the production of polymeric foams can be utilized. Of particular importance are aromatic diisocyanates such as toluene and diphenylmethane diisocyanates in pure, modified, or crude form. MDI variants (diphenylmethane diisocyanate modified by the introduction of urethane, allophanate, urea, biuret, carbodiimide, uretonimine, or isocyanurate residues) and the mixtures of diphenylmethane diisocyanates and oligomers thereof known in the art as crude or polymeric MDI (polymethylene polyphenylene polyisocyanates) are especially useful. Representative examples of suitable polyisocyanates include ethylene diisocyanate, 1,4-tetramethylene diisocyanate, 1,6-hexamethylene diisocyanate, trimethyl hexamethylene diisocyanate, 1,1,2-dodecane diisocyanate, cyclobutane-1,3-diisocyanate, cyclohexane-1,3- and 1,4-diisocyanate (and mixtures of these isomers), diisocyanto-3,3,5-trimethyl-5-isocyanatomethyl cyclohexane, 2,4- and 2,6-toluene diisocyanate (and mixtures of these isomers), diphenylmethane-2,4′- and/or 4,4′;-diisocyanate, naphalene-1,5-diisocyanate, the reaction products of four equivalents of the above-mentioned isocyanate-containing compounds with compounds containing two isocyanate-reactive groups, triphenyl methane-4,4′,4″-triisocyanate, polymethylene polyphenylene polyisocyanates, m- and p-isocyanatophenyl sulfonyl isocyanates, perchlorinated aryl polyisocyanates, polyisocyanates containing carbodiimide groups, norbornane diisocyanates, polyisocyanates containing allophanate groups, polyisocyanates containing polyisocyanurate groups, polyisocyanates containing urethane groups, polyisocyanates containing biuret groups, polyisocyanates produced by telomerization reactions, polyisocyanates containing ester groups, reaction products of the above-mentioned diisocyanates with acetals, polyisocyanates containing polymeric fatty acid esters, and mixtures thereof. Distillation residues (obtained in the commercial production of isocyanates) having isocyanate groups can also be used alone or in solution in one or more of the above-mentioned polyisocyanates.

Polyols suitable for use in the process of this invention are those having at least two isocyanate-reactive hydrogen atoms in the form of a hydroxyl group. Preferred polyols are those having from 2 to about 50, preferably from 2 to about 8, more preferably from 2 to about 4, hydroxyl groups. Such polyols can be, e.g., polyesters, polyethers, polythioethers, polyacetals, polycarbonates, polymethacrylates, polyester amides, or hydroxyl-containing prepolymers of these compounds and a less than stoichiometric amount of polyisocyanate. Generally, the polyol compounds utilized in the preferred process have a weight average molecular weight of from about 50 to about 50,000, preferably from about 500 to about 25,000.

Representative examples of suitable polyols have been described, e.g., by J. H. Saunders and K. C. Frisch in High Polymers, Volume XVI, “Polyurethanes,” Part I, pages 32-54 and 65-88, Interscience, New York (1962). Mixtures of such compounds are also useful, and, in some cases, it is particularly advantageous to combine low-melting and high-melting compounds with one another, as described in DE 2,706,297 (Bayer AG). Useful polyols include ethylene glycol, 1,2- and 1,3-propylene glycol, 1,4- and 2,3-butylene glycol, 1,5-pentane diol, 1,5-hexane diol, 1,8-octane diol, neopentyl glycol, 1,4-bis (hydroxymethyl)cyclohexane, 2-methyl-1,3-propane diol, dibromobutene diol, glycerol, trimethylolpropane, 1,2,6-hexanetriol, trimethylolethane, pentaerythritol, mannitol, sorbitol, diethylene glycol, triethylene glycol, tetraethylene glycol, higher polyethylene glycols, dipropylene glycol, higher propylene glycols, dibutylene glycol, higher polybutylene glycols, 4,4&#x2032;-dihydroxydiphenylpropane, and dihydroxymethyl hydroquinone.

In another aspect, the precursors of the foamable polymer of the present invention include a phenol and an aldehyde. In making the phenolic-based foam, the aldehyde, phenol and azeotrope-like composition can generally be combined, thoroughly mixed (using, e.g., any of the various known types of mixing head and spray apparatus), and permitted to expand and cure into a cellular polymer.

It is often convenient; but not necessary to preblend certain of the components of the foamable composition prior to reaction of the aldehyde and the phenol. For example, the azeotrope-like composition may be added to the phenol to form a first mixture and then blended with the aldehyde before vaporization and polymeric foam formation. Alternatively, the azeotrope-like composition can be added to the aldehyde to form a first mixture and then blended with the phenol before vaporization and polymeric foam formation.

Catalysts suitable for use in the process for preparing polymeric foam of the invention include compounds that greatly accelerate the reaction of the polyol-containing compounds with the isocyanates (or polyisocyanates). When used, catalysts are generally present in amounts sufficient to be catalytically effective. Suitable catalysts include organic metal compounds (preferably, organic tin compounds), which can be used alone or, preferably, in combination with strongly basic amines. Representative examples of these and other types of suitable catalysts are described in U.S. Pat. No. 4,972,002 (Volkert), the descriptions of which are incorporated herein by reference.

The process of the invention may further comprise adding a surfactant to the foamable mixture comprising the azeotrope-like composition and at least one foamable polymer or the precursors of at least one foamable polymer. Suitable surfactants include fluorochemical surfactants, organosilicone surfactants, polyethylene glycol ethers of long chain alcohols, tertiary amine or alkanolamine salts of longchain alkyl acid sulfate esters, alkyl sulfonate esters, alkyl arylsulfonic acids, fatty acid alkoxylates, and mixtures thereof. Surfactant is generally employed in amounts sufficient to stabilize the foaming reaction mixture against collapse and the formation of large, uneven cells. Organosilicone surfactants and fluorochemical surfactants are preferred.

Foams prepared from the process of the invention can vary in texture from vary in texture from very soft types useful in upholstery applications to rigid foams useful as structural or insulating materials. The foams can be used, for example, in the automobile, shipbuilding, aircraft, furniture, and athletic equipment industries, and are especially useful as insulation materials in the construction and refrigeration industries.

Advantages and embodiments of this invention are further illustrated by the following examples, but the particular materials and amounts thereof recited in these examples, as well as other conditions and details, should not be construed to unduly limit this invention. All materials are commercially available or known to those skilled in the art unless otherwise stated or apparent.

### EXAMPLES

The preparation, identification, and testing of the azeotrope-like compositions of this invention are further described in the following examples. The particular materials and amounts thereof recited in these examples, as well as other conditions and details, should not be construed to unduly limit this invention. In these examples, all percentages, proportions and ratios are by weight unless otherwise indicated. Foreseeable modifications and alterations of this invention will be apparent to those skilled in the art without departing from the scope and spirit of this invention. This invention should not be restricted to the embodiments that are set forth in this application for illustrative purposes.

### Example 1 and 2

1,1,1,3,3-pentafluorobutane (HFC365) was obtained from Solvay Chemicals US, Houston, Tex. Perfluoroheptane, C₇F₁₆, PF-5070 was obtained from 3M Company under the trade designation of PF-5070, St. Paul, Minn. Perfluoro-N-methyl morpholine (PNMM) [was obtained from 3M Company, St. Paul, Minn. under the trade designation of PF-5052.

Mixtures of 1,1,1,3,3-pentafluorobutane and either perfluoroheptane or perfluoro-N-methyl morpholine were distilled at ambient pressure (722 to 741 torr=96 to 99 kPa) to identify whether they formed a binary azeotrope, and if so, the composition (% by weight) and boiling point (b.p ° C.) of the azeotrope, using the following procedure. The mixtures were prepared and distilled at ambient lab pressure (722 to 741 torr=96 to 99 kPa) in a concentric tube distillation column (Model 933 available from Ace Glass, Vinland, N.J.). In each case, the distillation was allowed to equilibrate at total reflux for at least 60 minutes. For each distillation, five successive distillate samples, each approximately 10 percent by volume of the total liquid charge, were taken while operating the column at a liquid reflux ratio of 10 to 1. The compositions of the distillate samples were then analyzed using an HP-7890A Gas Chromatograph with a Quadrex capillary column 007-1-25W-5.0F (available from Quadrex Corporation, Woodbridge, Conn.) and a thermal conductivity detector. The boiling point of each distillate was measured using a thermocouple. Using this test procedure, the azeotropic compositions were identified as a result of 3 successive distillations (the distillate of the previous distillation forms the starting composition for the next distillation). The results were recorded in Table 1 below.

TABLE 1

| | | | Component | | |
|---|---|---|---|---|---|
| Ex- | | HFC365 | 2 | Boiling | Pressure |
| am- | | Conc. | Conc. | Pt. | torr |
| ple | Composition | (wt %) | (wt %) | (° C.) | (kPa) |
| 1 | HFC365/C7F16 | 88.7% | 11.3% | 38.3 | 732 (97.6) |
| 2 | HFC365/PNMM | 49.1% | 50.9% | 34.3 | 735 (98.0) |

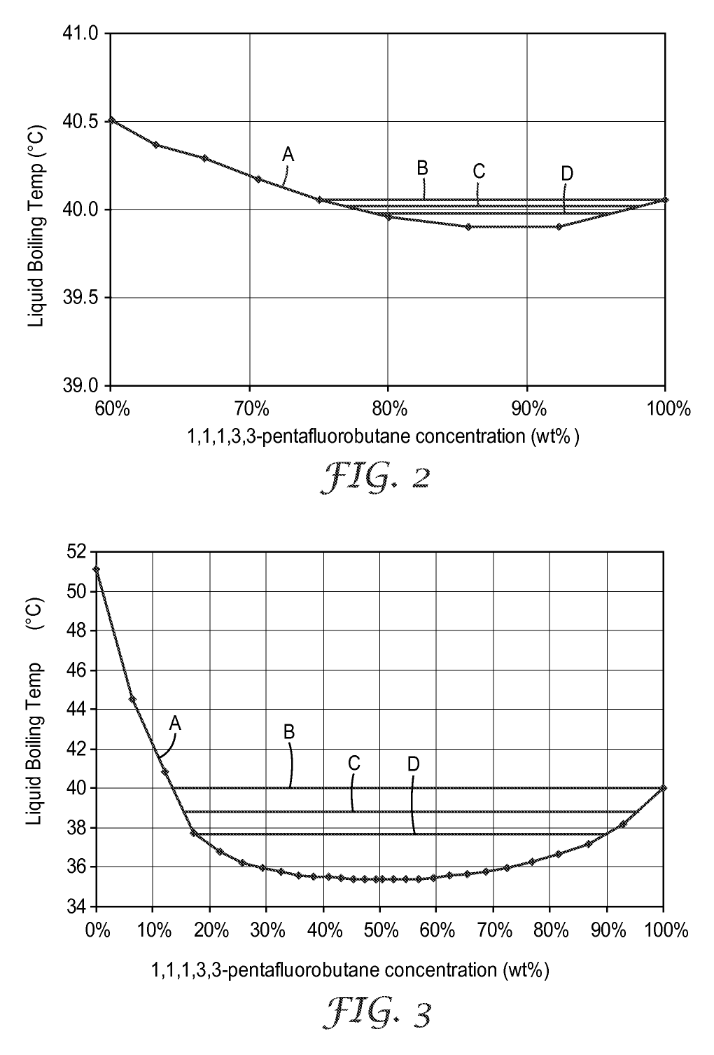

Percentage ranges for the azeotrope-like compositions of the invention were identified by determining boiling points of test mixtures of 1,1,1,3,3-pentafluorobutane and the perfluorocarbon using an ebulliometer or boiling point apparatus (specifically a Model MBP-100 available from Cal-Glass for Research, Inc, Costa Mesa, Calif.). 30 mL of 1,1,1,3,3-pentafluorobutane was added to the boiling point apparatus. The liquid was heated and allowed to equilibrate to its boiling point (typically about 30 minutes). After equilibration, the boiling point was recorded, an approximately 1.0 mL aliquot of perfluorocarbon (either the perfluoro-N-methyl morpholine or the perfluoroheptane) was added to the apparatus, and the resulting new composition was allowed to equilibrate for about 10 minutes, at which time the boiling point was recorded. The test continued basically as described above, with additions to the test mixture of about 1.0 mL of the perfluorocarbon every 10 minutes until 25 to 30 mL of perfluorocarbon had been added. The test was repeated by initially placing the perfluorocarbon into the apparatus and adding approximately 1.0 mL aliquots of 1,1,1,3,3-pentafluorobutane. The boiling points of the resulting mixtures are plotted in FIGS. 2 and 3.

The concentrations of the 1,1,1,3,3-pentafluorobutane and the perfluorocarbon may vary somewhat from the azeotrope formed between them. However, in all cases the boiling points of the azeotrope-like compositions are below the boiling point of 1,1,1,3,3-pentafluorobutane which is the minimum boiling component as shown in FIGS. 2 and 3. All boiling point determinations were made at standard pressure (760±1 torr=101 kPa).

1. An azeotrope-like composition comprising a blend of 1,1,1,3,3-pentafluorobutane and one of perfluoroheptane or perfluoro-N-methylmorpholine;
(i) wherein the blend consists essentially of less than 99.9 to about 75.1 weight percent of 1,1,1,3,3-pentafluorobutane and greater than 0.1 to about 24.9 weight percent of perfluoroheptane that boil below about 40.05° C. at about 760 torr (101 kilopascals);
(ii) wherein the blend consists essentially of less than 99.9 to about 13.5 weight percent of 1,1,1,3,3-pentafluorobutane and greater than 0.1 to about 86.5 weight percent of perfluoro-N-methylmorpholine that boil below about 40° C. at about 760 torr (101 kilopascals).

2. The azeotrope-like composition of claim 1,
(i) wherein the blend consists essentially of less than 98.2 to about 76.5 weight percent of 1,1,1,3,3-pentafluorobutane and greater than 1.8 to about 23.5 weight percent of perfluoroheptane that boil below about 40.02° C. at about 760 torr (101 kilopascals);
(ii) wherein the blend wherein the blend consists essentially of less than 95.5 to about 15.5 weight percent of 1,1,1,3,3-pentafluorobutane and greater than 4.5 to about 84.5 weight percent of perfluoro-N-methylmorpholine that boil below about 38.8° C. at about 760 torr (101 kilopascals).

3. The azeotrope-like composition of claim 1, wherein the blend is selected from:
(i) wherein the blend wherein the blend consists essentially of less than 96.2 to about 78.5 weight percent of 1,1,1,3,3-pentafluorobutane and greater than 3.8 to about 21.5 weight percent of perfluoroheptane that boil below about 39.98° C. at about 760 torr (101 kilopascals);
(ii) wherein the blend wherein the blend consists essentially of less than 90.0 to about 17.0 weight percent of 1,1,1,3,3-pentafluorobutane and greater than 10.0 to about 83.0 weight percent of perfluoro-N-methylmorpholine that boil below about 37.7° C. at about 760 torr (101 kilopascals).

4. The azeotrope-like composition of claim 1, wherein the composition is an azeotrope and the blend is selected from:
(i) wherein the composition is an azeotrope wherein the blend consists essentially of 88.7 weight percent of 1,1,1,3,3-pentafluorobutane and 11.3 weight percent of perfluoroheptane that boils at about 38.3° C. at about 732 torr (97.6 kilopascals);
(ii) wherein the composition is an azeotrope wherein the blend consists essentially of 49.1 weight percent of 1,1,1,3,3-pentafluorobutane and 50.9 weight percent of perfluoro-N-methylmorpholine that boils at about 34.3° C. at about 735 torr (98.0 kilopascals).

5. A coating composition comprising an azeotrope-like composition according to claim 1 and at least one coating material.

6. A coated article comprising a substrate having a first surface, wherein the coating composition of claim 5 contacts at least a portion of the first surface.

7. A process for depositing a coating on a substrate surface comprising applying the coating composition of claim 5 to at least a portion of at least one surface of the substrate, wherein the at least one coating material is soluble or dispersible in the azeotrope-like composition.

8. A process for foam blowing comprising vaporizing the azeotrope-like composition of claim 1 in the presence of at least one foamable polymer or the a precursors of a foamable polymer.

9. A polymeric foam prepared by the process of claim 8.

10. A process for removing contaminants from the surface of a substrate comprising the steps of contacting the substrate with one or more of the azeotrope-like compositions according to claim 1 until the contaminants are dissolved, dispersed, or displaced in or by the azeotrope-like composition, and removing the azeotrope-like composition containing the dissolved, dispersed or displaced contaminants from the surface of the substrate.

11. A process for heat transfer wherein at least one of the azeotrope-like compositions according to claim 1 is used as a heat-transfer fluid.

12. The process of claim 11 wherein the azeotrope-like compositions are used in an organic Rankine cycle.
